(19) United States
(12) Patent Application Publication
(10) Pub. No.: US 2004/0246704 A1
(43) Pub. Date: Dec. 9, 2004

(54) Led night-light

(76) Inventor: Brian Burdick, West Henrietta, NY (US)

Correspondence Address: Thomas R. FitzGerald, Esq., Suite 210, 16 E. Main Street, Rochester, NY, 14614-1803, US

(21) Appl. No.: 10/802,234

(22) Filed: Mar. 17, 2004

Related U.S. Application Data
(60) Provisional application No. 60/456,210, filed on Mar. 20, 2003.

(51) Int. Cl. H01R 33/00

(52) U.S. Cl. 362/95; 362/29; 362/100; 362/104; 362/800; 362/812; 362/226

(57) ABSTRACT

An LED night light has a body 10 with side walls 20, 22 and end walls 12, 13. The body is made of translucent or clear or colored resin and the circuit components 30 and LED 32 can be seen through the clear resin. A safety tang 50 extends from inside the body and has a hole for receiving the mounting screw of an outlet. The light may be secured to the outlet to prevent a child or other person from removing it. A pair of prongs 18, 19 extend from the circuit components to the outside and fit into a conventional 120 volts ac receptacle. A name plate 24 is embedded in the body and captures the light from LED 32 to illuminate the name on the plate. The name may be the name of a person or a product, so that advertisements are embedded in the resin and illuminated by the LED.

### BACKGROUND

Night lights have many uses. Some are used in a child's room to sooth an anxious child at bed time. Others provide some illumination for halls and rooms to let a sleeper who wakens during the night find his or her way about a house without turning on a larger light that would awaken other sleepers. Some conventional night lights are made with incandescent lamps. One drawback of such lamps is that they are hot to the touch and may have a relatively short life. Other night lights are made with fluorescent lamps, but they are often bulky and expensive due to the ballast needed for the fluorescent lamp. Accordingly, there is an unmet need for a long lasting, cool, small night light.

### SUMMARY

The invention provides a night light that has a clear resin body with an encapsulated light emitting diode (LED). The night light has a printed circuit board that holds an ac to dc converter circuit. The converter circuit converts household alternating current and voltage into a direct current and voltage suitable for powering the LED. In one embodiment the converter circuit is a full wave bridge. The night light has a name plate operatively associated with the LED for illuminating indicia on the name plate. The name plate may carry indicia of the name of the occupant of the room illuminated by the night light. It also has a safety tang extending from the body and having an opening for receiving a fixture screw. The safety tang prevents a child from removing the light from a receptacle. In another embodiment, the night light is provided with a screw in connector for inserting the new night light into existing night light fixtures.

### DRAWINGS

FIG. 1 is a side sectional view of the LED night light.

FIG. 2 is a top view of the LED night light showing the name plate.

FIG. 3 is an end view of the LED night light.

FIG. 4 is an electrical schematic view of the converter circuit.

FIG. 5 is photograph of an LED night light encapsulated in clear plastic.

FIGS. 6-10 are views of an alternate embodiment of the LED night light with a screw connector for conventional night light fixture.

### DETAILED DESCRIPTION

The light is cast in a solid block of translucent or clear plastic resin and has brass contacts. All of the internal parts are clearly visible and the unit is 100% waterproof. The light source is a 7300 mcd super white LED with a lifetime of approximately 100,000 hours, or over 10 years of continuous use and is not affected by vibration. The light output is about equivalent to a conventional seven watt incandescent night-light bulb except the light is white instead of yellowish. This unit operates on 120 volts AC, using less than one watt of power and is totally cool to the touch. This light can be built with any color LED and more than one LED per light. Flashing LED's or automatic color changing LED's can also be used. The solid plastic block design diffuses the LED's light so that it won't damage the eye if someone stares directly at it. The plastic is translucent and may be clear or have one or more colors. This solid block can be molded in any size or shape that will contain the circuit. This light can be used for a room night-light or for advertising. Plastic light conducting pieces that spell out names can be inserted into the plastic block so the LED lights them up. Changing one part can easily change the circuit to operate on 220 volts. The wiring schematic and an actual life-size picture are shown below.

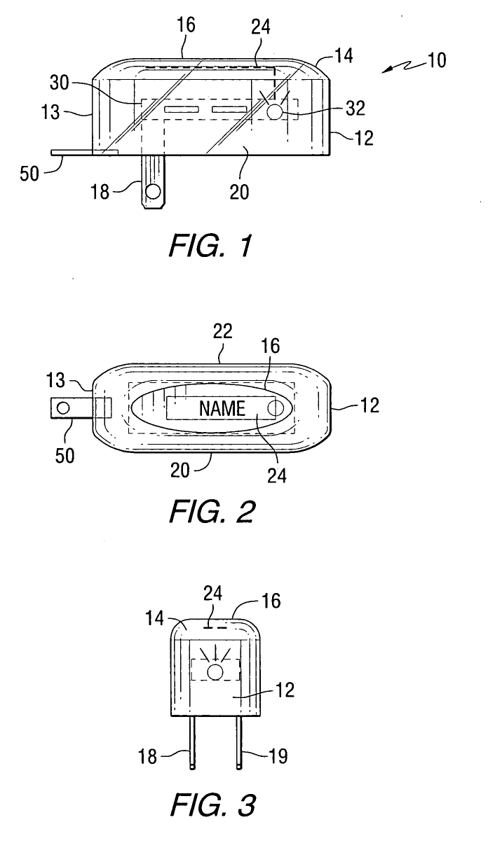

An example is shown in FIGS. 1-4 and in photo FIG. 5. The body 10 has side walls 20, 22 and end walls 12, 13. A sloped, curved annular wall 14 extends from the sidewalls and end walls to a top surface16. The top surface 16 has an oval or oblong shape. The body is made of clear resin and the circuit components 30 and LED 32 can be seen through the clear resin. A safety tang 50 extends from inside the body and has a hole for receiving the mounting screw of an outlet. The light may be secured to the outlet to prevent a child or other person from removing it. A pair of prongs 18, 19 extend from the circuit components to the outside and fit into a conventional 120 volts ac receptacle. Of course, prongs of other shapes may be made for other voltage systems. A name plate 24 is embedded in the body and captures the light from LED 32 to illuminate the name on the plate. The name may be the name of a person or a product, so that advertisements are embedded in the resin and illuminated by the LED.

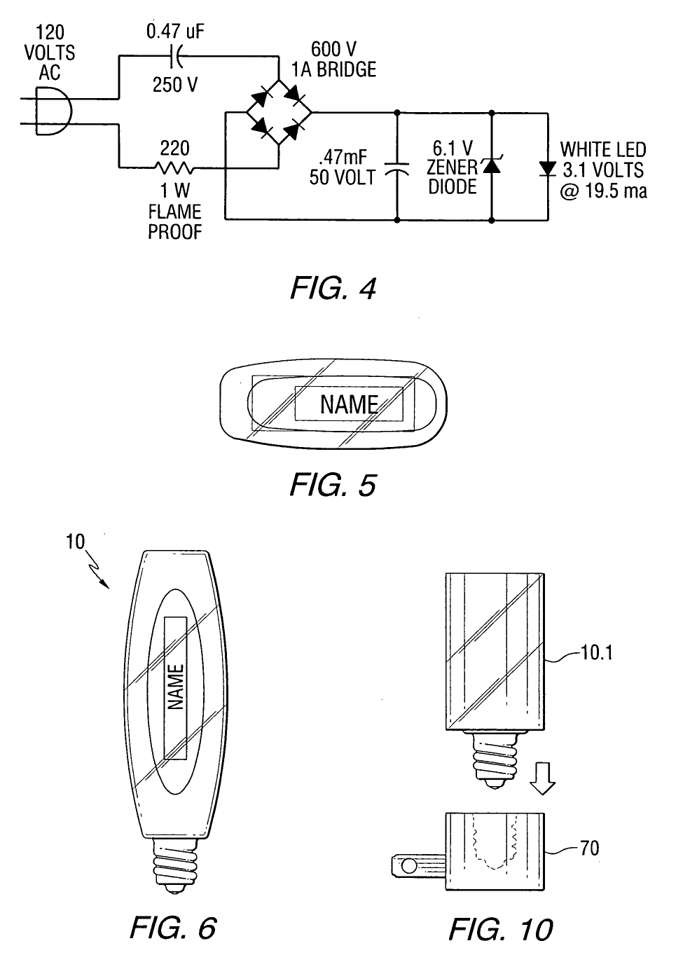

The circuit includes two capacitors, a full wave bridge to convert ac to dc, a zener diode and an LED. See the circuit diagram of FIG. 4. A photo of a sample product is shown in FIG. 5. Suitable optics are added to the LED including a diffuser to reduce the intensity of the light and spread the light out. The invention may include two or more LEDs with the LEDs connected in series. The preferred embodiment has no switch and is waterproof. A magnetic switch could be added if desired by placing a reed switch in the circuit and providing a holder for a magnet on the outside body. Placing the magnet in the holder will operate the reed switch. The circuit components are disposed in the resin without a circuit board and they appear to float in the resin to provide a pleasing appearance to the viewer. The overall shape is also pleasing to the viewer.

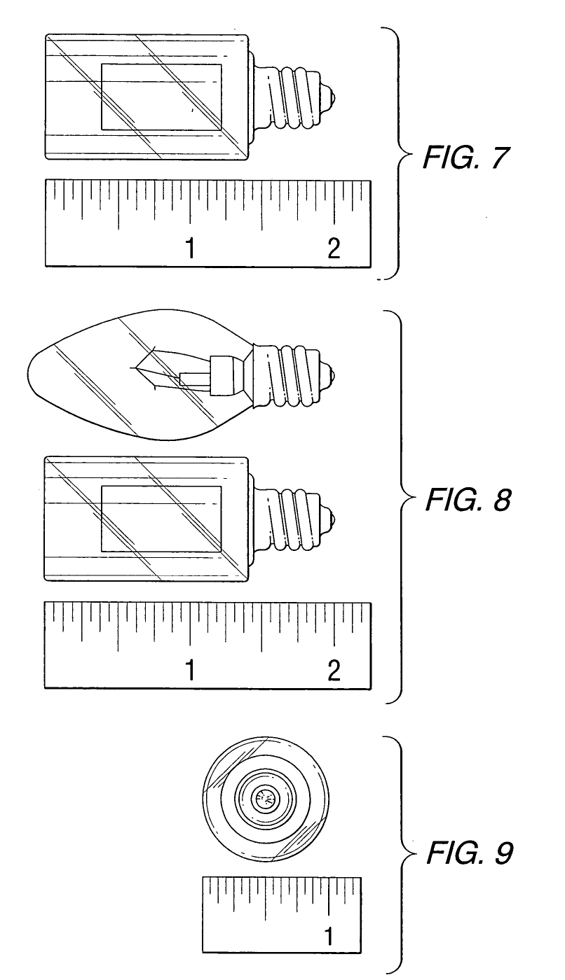

As shown in FIGS. 6-10, the LED night light may have a screw connector 58 instead of the pairs of prongs 18. The screw connector embodiment allows a user to insert the LED night light into an existing night light fixture that has a conventional screw receiving base. The body 10.1 may be formed into a cylindrical shape or molded into any suitable shape. The screw connector engages and fits into the base of a conventional night light fixture 70 as shown in FIG. 10.

Having thus shown and described several embodiments of the invention, those skilled in the art understand that changes, substitutions, additions and deletions to the elements in the embodiments may be made without departing from the spirit and scope of the following claims.

1. An LED night light comprising a translucent resin body with a light emitting diode (LED), an ac to dc converter disposed in the body and connected at one end to the LED and at the other end to leads that extend from the ac to dc converter to the outside of the body for contacting an ac source.

2. The LED night light of claim 1 wherein the as to dc converter comprises a full wave bridge.

3. The LED night light of claim 1 further comprising a name plate operatively associated with the LED for illuminating indicia on the name plate.

4. The LED night light of claim 1 further comprising a safety tang extending from the body and having an opening for receiving a fixture screw.

5. The LED night light of claim 1 wherein the leads are connected to either a pair of prongs or a screw connector for screw attaching to a threaded electrical receptacle.
